(19) United States
(12) Patent Application Publication
(10) Pub. No.: US 2019/0182602 A1
(43) Pub. Date: Jun. 13, 2019

(54) SOUND-PRODUCING DEVICE

(71) Applicant: ALPS ALPINE CO., LTD., Tokyo (JP)

(72) Inventors: Taishi NUMATA, Niigata-Ken (JP); Daigo AOKI, Niigata-Ken (JP); Kiyoshi SATO, Niigata-Ken (JP); Yutaka SATO, Niigata-Ken (JP)

(21) Appl. No.: 16/276,928

(22) Filed: Feb. 15, 2019

Related U.S. Application Data
(63) Continuation of application No. PCT/JP2017/008268, filed on Mar. 2, 2017.

(30) Foreign Application Priority Data
Aug. 16, 2016 (JP) 2016-159667

(51) Int. Cl. H04R 11/02

(52) U.S. Cl. CPC H04R 11/02

(57) ABSTRACT

A sound-producing device includes, in a case, a yoke formed of a magnetic material, a magnet supported by the yoke, a coil, an armature extending through the coil and facing the magnet, and a vibrator configured to vibrate in response to operation of the armature. The yoke is formed of an Fe—Ni alloy containing 32% by mass to 40% by mass of Ni.

### CLAIM OF PRIORITY

This application is a Continuation of International Application No. PCT/JP2017/008268 filed on Mar. 2, 2017, which claims benefit of Japanese Patent Application No. 2016-159667 filed on Aug. 16, 2016. The entire contents of each application noted above are hereby incorporated by reference.

### BACKGROUND OF THE INVENTION

### 1. Field of the Invention

The present invention relates to a sound-producing device that includes an armature extending through a coil and facing a magnet supported by a yoke and that produces a sound as vibrations of the armature are transmitted to a vibrator.

### 2. Description of the Related Art

Japanese Unexamined Patent Application Publication No. 2013-138292 discloses an invention related to a sound-producing device (electroacoustic transducer).

This sound-producing device includes a direct-current magnetic field generator. The direct-current magnetic field generator includes a first yoke, a second yoke, and a pair of permanent magnets supported by the respective yokes. An air core coil is disposed adjacent to the yokes, and the armature is disposed between the pair of opposing permanent magnets and inside the air core coil.

The armature is coupled to a vibrating plate by a rod. The armature vibrates in response to a current supplied to the coil, and these vibrations are transmitted to a vibrator, thus producing a sound.

The above publication discloses that the yokes are formed of PB permalloy (40-50% Ni—Fe).

PB permalloy (40-50% Ni—Fe) is used for the yokes supporting the permanent magnets of the sound-producing device (electroacoustic transducer) disclosed in the above publication. PB permalloy, which has a high magnetic saturation, i.e., 1.5 T or more, and good soft magnetic properties, is commonly used for various magnetic circuits.

However, it is not necessarily the best to select PB permalloy as a soft magnetic material for the yokes of a sound-producing device (electroacoustic transducer).

As described later with reference to FIGS. 8A and 8B, the sound pressure level (SPL) of a sound-producing device including yokes formed of PB permalloy tends to show relatively large ripple noise at high frequencies of 2 kHz or more. It can be assumed that this is partly because an increased amount of heat is generated from the coil at high frequencies and increases the temperature of the yokes, which are adjacent to the coil in a narrow case. It is also assumed that ripple noise tends to occur at high frequencies when the ambient temperature increases.

As described later with reference to FIG. 7, PB permalloy has a linear expansion coefficient α of more than 10×10⁻⁶. Thus, as an increased amount of heat is generated from the coil and heats the yokes, the yoke size changes, which tends to vary the distance between the opposing magnets.

It is possible that this distance variation results in unnecessary vibrations of the armature.

It is also assumed that another cause is as follows. As an increased amount of heat is generated from the coil and changes the yoke size, the internal stress at the junctions between the magnets and the yokes and the junction between the yokes increases. As a result, when the magnetic flux generated from the magnets is transmitted to the armature, the flow regularity of the magnetic flux passing inside the yokes is degraded.

### SUMMARY OF THE INVENTION

The present invention provides a sound-producing device that exhibits a stable sound pressure level at high frequencies.

A sound-producing device according to an aspect of the present invention includes, in a case, a yoke formed of a magnetic material, a magnet supported by the yoke, a coil, an armature extending through the coil and facing the magnet, and a vibrator configured to vibrate in response to operation of the armature. The yoke is formed of an Fe—Ni alloy containing 32% by mass to 40% by mass of Ni.

In the sound-producing device according to the above aspect, the Fe—Ni alloy preferably contains 36% by mass of Ni.

The sound-producing device according to the above aspect may be configured such that the magnet is secured to each of opposing inner surfaces of the yoke, the armature being located between the opposing magnets.

The sound-producing device according to the above aspect preferably has a frame disposed in the case, the vibrator being supported on one side of the frame, the yoke being secured to another side of the frame.

Furthermore, the case of the sound-producing device according to the above aspect is preferably composed of first and second cases combined together, the frame being held and secured between the first and second cases.

The yoke of the sound-producing device according to the above aspect is formed of an Fe—Ni alloy containing 32% by mass to 40% by mass of Ni. As shown in FIG. 7, Fe—Ni alloys containing Ni in amounts within this range have low linear expansion coefficients α. As shown in FIGS. 8A and 8B, a sound-producing device including this yoke exhibits an improvement in terms of nipple noise at high frequencies.

According to the above aspect, even if an increased amount of heat is generated from the coil at high frequencies and increases the temperature of the yoke, which is housed in a narrow case, the change in yoke size can be reduced through the use of a yoke containing Ni in an amount within the above range. As a result, less variation occurs in the distance between the opposing magnets, and an increase in internal stress at the junctions between the yoke and the magnets and the junction between different parts of the yoke can be more easily prevented. The change in yoke size can also be reduced when the ambient temperature increases, and therefore, an increase in internal stress can be more easily prevented.

Thus, the sound pressure level at high frequencies of 2 kHz or more can be stabilized.

### BRIEF DESCRIPTION OF THE DRAWINGS

FIG. 1 is a perspective view showing the external appearance of a sound-producing device according to an embodiment of the present invention;

FIG. 2 is an exploded perspective view showing the sound-producing device according to the embodiment of the present invention;

FIG. 3 is a sectional view, taken along line III-III, of the sound-producing device shown in FIG. 1;

FIG. 4 is a sectional view showing the sound-producing device shown in FIG. 3 in a disassembled state;

FIG. 5 is a plan view of a frame of the sound-producing device according to the embodiment, with a vibrating plate, a first yoke, and an armature mounted thereon;

FIG. 6 is a sectional view, taken along line VI-VI, of the sound-producing device shown in FIG. 3;

FIG. 7 is a graph showing the relationship between the Ni content and linear expansion coefficient of Fe—Ni alloys for forming yokes (source: PHYSICS & APPLICATIONS OF PROPERTIES OF INVAR ALLOYS, P4 (Maruzen Publishing Co., Ltd.));

FIG. 8A is a characteristic graph showing the relationship between frequency and SPL for the Example; and

FIG. 8B is a characteristic graph showing the relationship between frequency and SPL for the Comparative Example.

### DESCRIPTION OF THE PREFERRED EMBODIMENTS

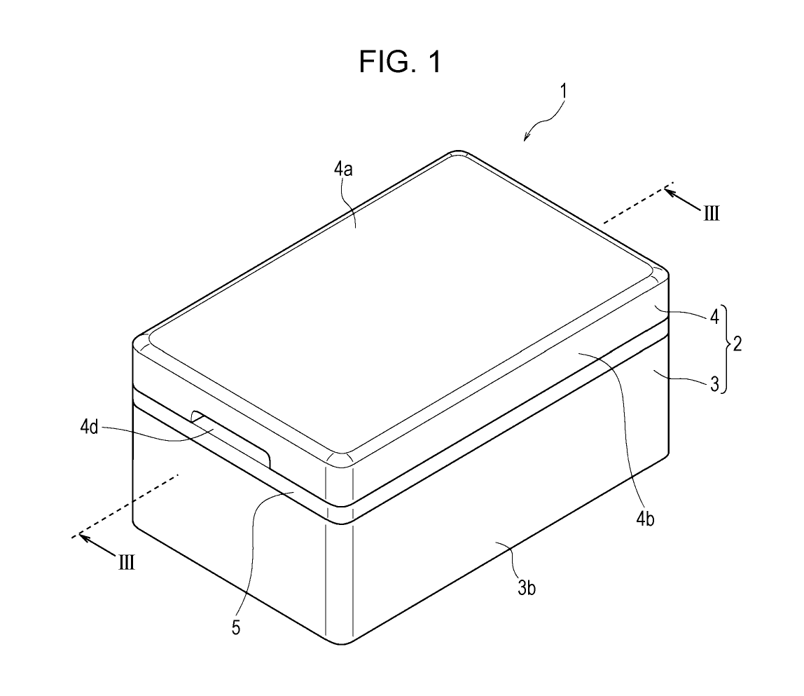

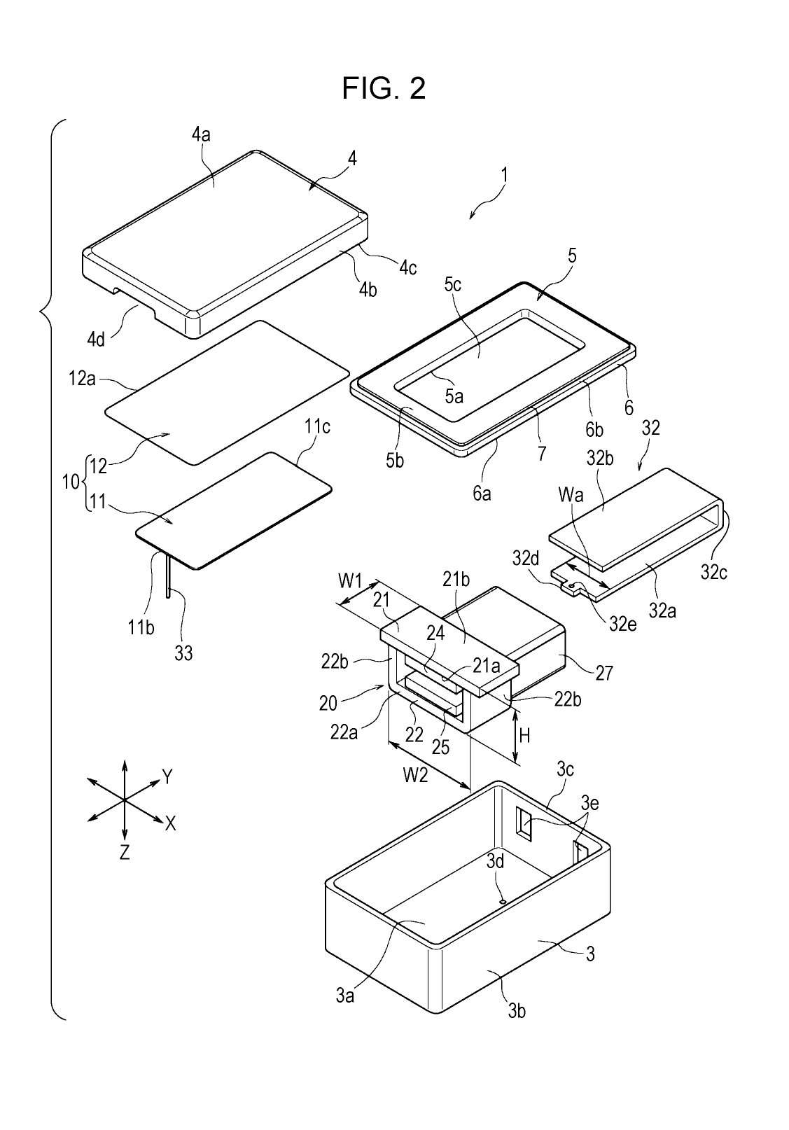

As shown in, for example, FIGS. 1 and 2, a sound-producing device 1 according to an embodiment of the present invention includes a case 2. The case 2 is composed of a first case 3 and a second case 4. The first case 3 is a lower case, whereas the second case 4 is an upper case. Both cases 3 and 4 are formed from a nonmagnetic metal plate or a magnetic metal plate by press forming.

As shown in FIG. 2, the first case 3 has a bottom 3a, a sidewall 3b enclosing the four sides thereof, and an opening edge 3c at the upper end of the sidewall 3b. The second case 4 has a ceiling 4a, a sidewall 4b enclosing the four sides thereof, and an opening edge 4c at the lower end of the sidewall 4b. The first case 3 has a larger inner space than the second case 4, which functions as a lid for the first case 3.

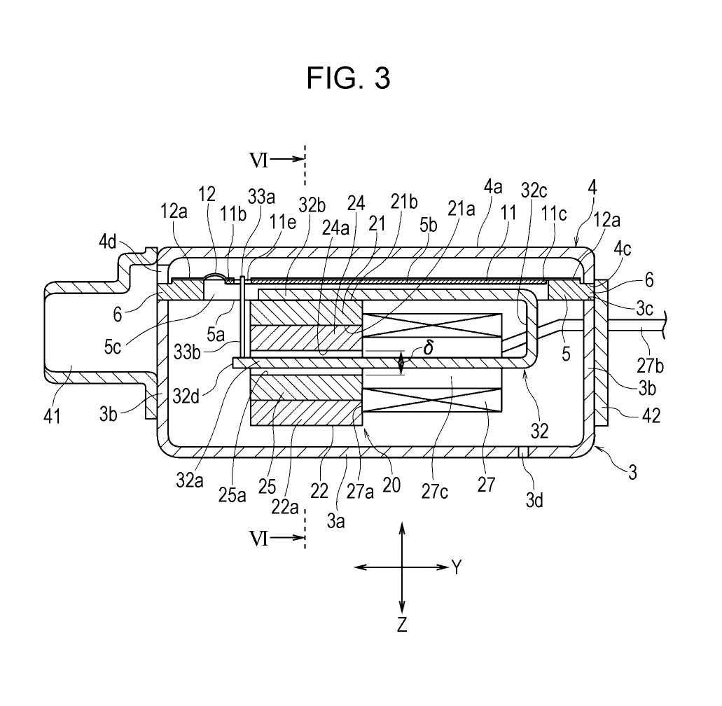

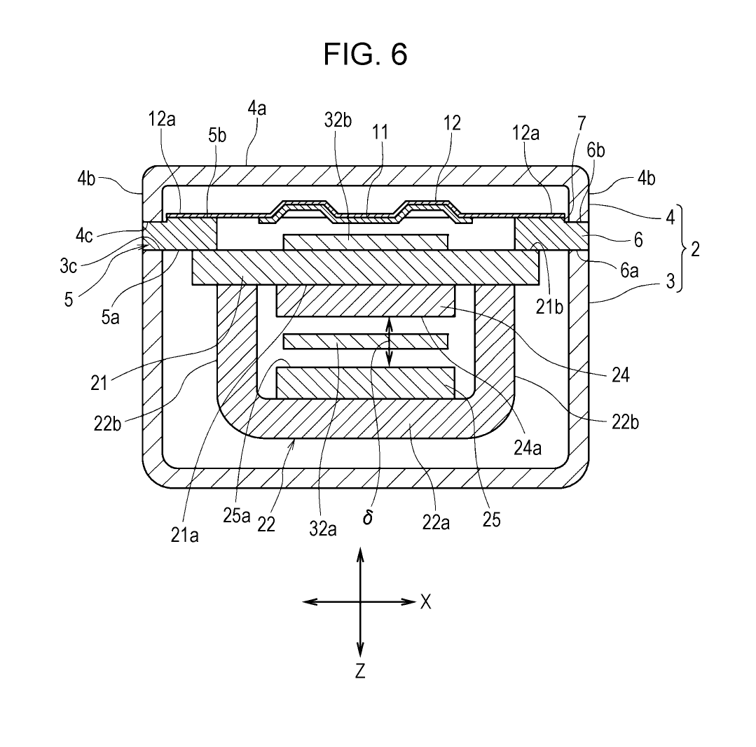

As shown in FIGS. 3 and 6, a frame 5 is held between the opening edge 3c of the first case 3 and the opening edge 4c of the second case 4. As shown in FIG. 2, the frame 5 is formed from a nonmagnetic or magnetic metal plate with uniform thickness in the Z direction. The frame 5 has an opening 5c formed through the center thereof from top to bottom. The opening 5c is a rectangular hole.

The frame 5 has a vibrator-mounting surface 5b around the opening 5c in the upper surface thereof as shown in the figures. The vibrator-mounting surface 5b is a frame-shaped flat surface. The frame 5 has a held portion 6 with reduced thickness that is integrally formed around the entire periphery of the vibrator-mounting surface 5b. As shown in FIGS. 3, 4, and 6, the upper surface of the held portion 6 oriented in the same direction as the vibrator-mounting surface 5b is an upper joining contact surface 6b. A step 7 is formed between the vibrator-mounting surface 5b and the upper joining contact surface 6b.

This frame 5 is manufactured by press-forming a metal plate with uniform thickness. The opening 5c is formed by punching the metal plate. The held portion 6 is formed by pressing the periphery of the vibrator-mounting surface 5b so that its thickness in the Z direction is reduced. This pressing not only forms the held portion 6, but also increases the rigidity of the frame 5.

The lower surface, as shown in the figures, around the opening 5c in the frame 5 is a drive-mechanism mounting surface 5a, and the surface of the held portion 6 facing downward as shown in the figures is a lower joining contact surface 6a. The drive-mechanism mounting surface 5a and the lower joining contact surface 6a are the same flat surface. Alternatively, there may be a step between the drive-mechanism mounting surface 5a and the lower joining contact surface 6a.

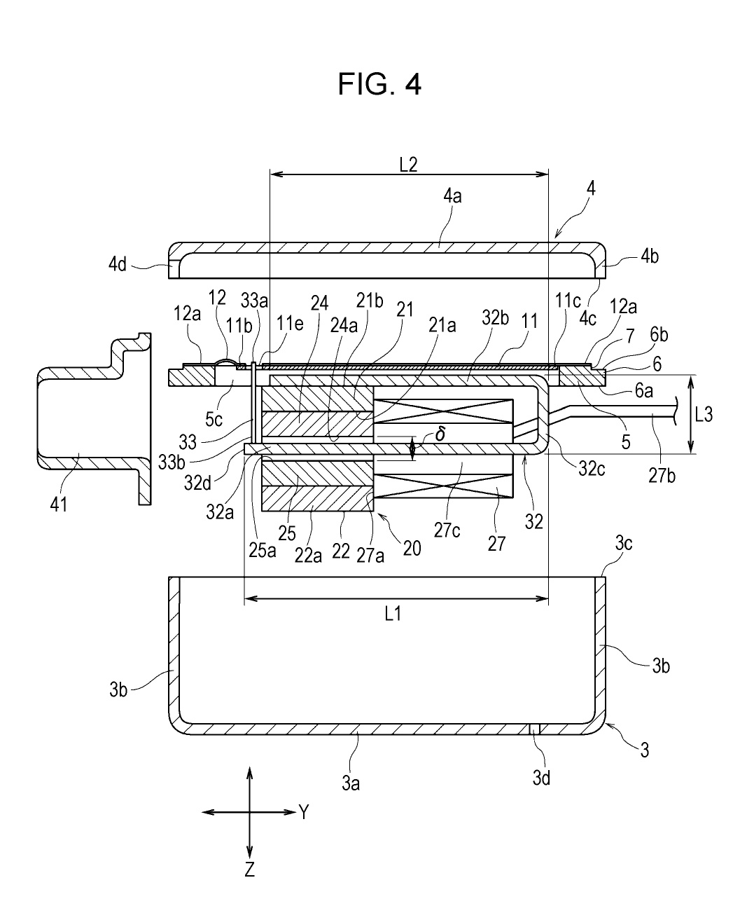

As shown in FIGS. 3 and 4, a vibrator 10 is mounted on the vibrator-mounting surface 5b of the frame 5, which faces upward as shown in the figures. The vibrator 10 is composed of a vibrating plate 11 and a vibration support sheet 12. The vibrating plate 11 is formed from a thin plate of a metal material such as aluminum or SUS304, optionally with a rib formed by press forming to enhance the bending strength. Although raised ribs are shown in FIG. 6, the ribs are omitted from FIG. 2. The vibration support sheet 12 is more flexible than the vibrating plate 11 and is formed from, for example, a sheet (film) of a resin such as polyethylene terephthalate (PET), nylon, or polyurethane.

The vibrating plate 11 and the vibration support sheet 12 are rectangular. The area of the vibrating plate 11 is smaller than the opening area of the opening 5c in the frame 5, and the area of the vibration support sheet 12 is larger than the area of the vibrating plate 11. As shown in FIG. 6, the vibrating plate 11 is secured to the lower surface of the vibration support sheet 12 by bonding with an adhesive. The outer periphery 12a of the vibration support sheet 12 is located outside the outer periphery of the vibrating plate 11. This outer periphery 12a is secured to the frame-shaped upper surface of the frame 5, i.e., the vibrator-mounting surface 5b, with an adhesive therebetween. The bending and elasticity of the vibration support sheet 12 allow the vibrating plate 11 to vibrate while being fixed at a fixed end 11c thereof such that a free end 11b thereof is displaced in the Z direction. The fixed end 11c and the free end 11b are shown in FIGS. 2, 3, and 4.

As shown in FIGS. 3 and 4, a magnetic-field generating unit 20, a coil 27, and an armature 32 are mounted on the frame 5. The magnetic-field generating unit 20 includes a first yoke 21 and a second yoke 22. The soft magnetic material forming the first yoke 21 and the second yoke 22 is a Ni—Fe alloy containing 32% by mass to 40% by mass of Ni.

As shown in FIG. 2, the second yoke 22 is bent into a U-shape and has a bottom 22a and a pair of sides 22b and 22b bent upward on both sides in the X direction. The upper ends of the sides 22b and 22b are joined to the inner surface 21a of the first yoke 21, which has a flat shape. The first yoke 21 and the second yoke 22 are secured together by a technique such as laser spot welding. When the first yoke 21 and the second yoke 22 are secured together, the inner surface of the bottom 22a of the second yoke 22 faces the inner surface 21a of the first yoke 21 so as to be parallel thereto.

As shown in FIGS. 2, 4, and 6, the magnetic-field generating unit 20 has a first magnet 24 secured to the inner surface 21a of the first yoke 21 and a second magnet 25 secured to the inner surface of the bottom 22a of the second yoke 22. The magnets 24 and 25 are magnetized such that a magnetized surface 24a of the first magnet 24 is of opposite polarity to a magnetized surface 25a of the second magnet 25. A gap δ is defined between the magnetized surface 24a of the first magnet 24 and the magnetized surface 25a of the second magnet 25 in the Z direction.

As shown in FIGS. 2 and 3, the coil 27 is disposed beside the magnetic-field generating unit 20. The coil 27 is a covered conductor wound multiple turns about a winding axis extending in the Y direction. A winding end 27a of the coil 27 oriented in the Y direction is secured to the first yoke 21 and the second yoke 22 by bonding. Alternatively, a support plate formed of a nonmagnetic material may be secured to the downward-facing outer surface of the first yoke 21, and the downward-facing outer winding portion of the coil 27 may be bonded to the support plate.

As shown in FIGS. 2, 3, and 4, the armature 32 is disposed in the sound-producing device 1. The armature 32 is formed from a plate of a magnetic material with uniform thickness, for example, a Ni—Fe alloy. The armature 32 is press-formed into a U-shape having a movable portion 32a, a base 32b, and a bend 32c. As shown in FIG. 2, a leading end 32d of the movable portion 32a of the armature 32 facing the free end side has a reduced width in the X direction and has a coupling hole 32e formed therethrough from top to bottom.

As shown in FIGS. 3, 4, and 5, the base 32b of the armature 32 is secured to an upward-facing outer surface 21b of the first yoke 21. The movable portion 32a of the armature 32 is inserted into the winding space 27c of the coil 27 and is also inserted into the gap δ between the first magnet 24 and the second magnet 25. The leading end 32d of the armature 32 protrudes out of the gap δ to the left as shown in the figures.

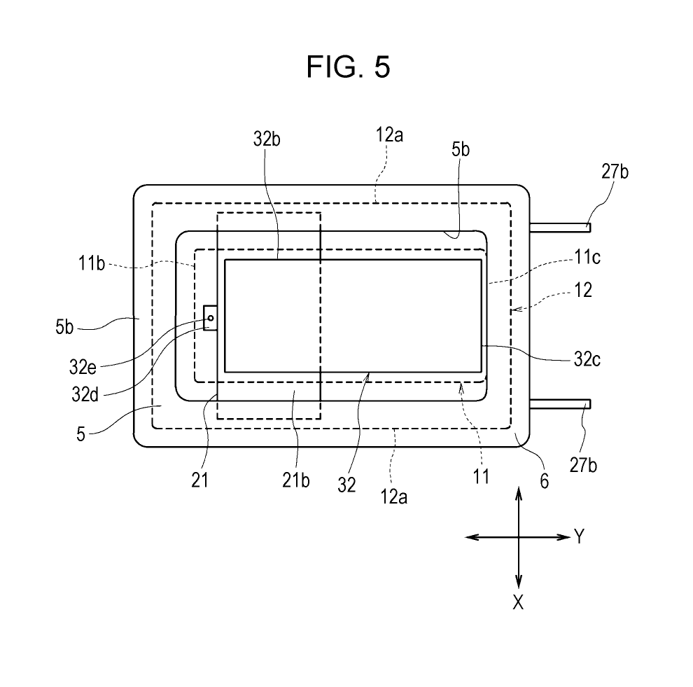

As shown in FIGS. 3 and 4, the upward-facing outer surface 21b of the first yoke 21 is joined and secured to the lower surface of the frame 5, i.e., the drive-mechanism mounting surface 5a. As shown in FIGS. 5 and 6, the first yoke 21 is disposed so as to cross the opening 5c in the frame 5 in the X direction, and both ends of the first yoke 21 in the X direction are joined to the drive-mechanism mounting surface 5a of the frame 5. The first yoke 21 and the frame 5 are secured together by laser spot welding. By securing together the first yoke 21 and the frame 5, the magnetic-field generating unit 20 is retained with respect to the drive-mechanism mounting surface 5a of the frame 5.

As shown in FIG. 5, the base 32b of the armature 32 is smaller than the opening area of the opening 5c in the frame 5. Thus, as shown in FIG. 6, when the outer surface 21b of the first yoke 21 is secured to the lower surface of the frame 5, i.e., the drive-mechanism mounting surface 5a, the base 32b of the armature 32, which is secured to the outer surface 21b, enters the opening 5c in the frame 5. The thickness of the base 32b in the Z direction is smaller than the thickness of the frame 5 in the Z direction. Thus, a gap is formed between the vibrating plate 11, which is also located in the opening 5c, and the base 32b of the armature 32 in the Z direction so that the vibrating plate 11 can vibrate in the Z direction.

As shown in FIG. 3, the free end 11b of the vibrating plate 11 is coupled to the leading end 32d of the armature 32 by a transmitter 33. The transmitter 33 is a needle-shaped member formed of a metal or a synthetic resin, for example, an SUS202 pin. An upper end 33a of the transmitter 33 is inserted into a mounting hole 11e formed in the vibrating plate 11, and the vibrating plate 11 and the transmitter 33 are secured together with an adhesive or solder. A lower end 33b of the transmitter 33 is inserted into the coupling hole 32e formed in the leading end 32d of the armature 32, and the transmitter 33 and the leading end 32d are secured together by laser spot welding or with an adhesive or solder. The transmitter 33 extends through the opening 5c in the frame 5 from top to bottom, and a portion of the transmitter 33 is located in the opening 5c.

As shown in FIGS. 3 and 6, the held portion 6 integrally formed around the periphery of the frame 5 is held and secured between the opening edge 3c of the first case 3 and the opening edge 4c of the second case 4. The opening edge 3c of the first case 3 abuts the lower surface of the held portion 6, i.e., the lower joining contact surface 6a, whereas the opening edge 4c of the second case 4 abuts the upper surface of the held portion 6, i.e., the upper joining contact surface 6b. The first case 3 and the second case 4 are secured to the held portion 6 by laser spot welding. Thus, the sound-producing device 1 shown in FIG. 1 is finished.

The held portion 6 is integrally formed around the entire periphery of the frame 5, and the step 7 is formed between the vibrator-mounting surface 5b and the upper surface of the held portion 6, i.e., the upper joining contact surface 6b. Thus, the junction between the upper joining contact surface 6b and the opening edge 4c of the second case 4 is discontinuous with the vibrator-mounting surface 5b at the step 7. The presence of the step 7 prevents the adhesive for bonding the outer periphery 12a of the vibration support sheet 12 to the vibrator-mounting surface 5b from adhering to the junction between the upper joining contact surface 6b and the opening edge 4c.

When the frame 5 is held and secured between the first case 3 and the second case 4, the vibrating plate 11 and the vibration support sheet 12 divide the inner space of the case 2 into upper and lower spaces. The inner space of the second case 4 above the vibrating plate 11 and the vibration support sheet 12 is a sound-producing space. The sound-producing space leads to the outer space through a sound outlet opening 4d formed in the sidewall 4b of the second case 4.

As shown in FIG. 3, a sound outlet nozzle 41 leading to the sound outlet opening 4d is secured outside the case 2. As shown in FIGS. 2 and 3, an air inlet/outlet opening 3d is formed in the bottom of the first case 3, and the inner space of the first case 3 below the vibrating plate 11 and the vibration support sheet 12 leads to the outside atmosphere through the air inlet/outlet opening 3d. As shown in FIG. 2, a pair of wire holes 3e are formed in the sidewall 3b of the first case 3. As shown in FIG. 3, a pair of terminal portions 27b of the conductor forming the coil 27 are routed outside through the wire holes 3e. A substrate 42 is secured outside the sidewall 3b of the first case 3, and the terminal portions 27b pass through small holes formed in the substrate 42. By closing these small holes, the wire holes 3e are closed off from the outside.

The operation of the sound-producing device 1 will be described next.

When a voice current is supplied to the coil 27, a magnetic field induced by the coil 27 and a magnetic field generated between the magnetized surface 24a of the first magnet 24 and the magnetized surface 25a of the second magnet 25 exert a vibrating force on the movable portion 32a of the armature 32 in the Z direction. These vibrations are transmitted through the transmitter 33 to the vibrating plate 11. The vibrating plate 11, which is supported by the vibration support sheet 12, vibrates while being fixed at the fixed end 11c thereof such that the free end 11b thereof oscillates in the Z direction. These vibrations are transmitted to the vibrating plate 11, thus producing a sound pressure in the inner sound-producing space of the second case 4. This sound pressure is output from the sound outlet opening 4d to the outside.

The features of the sound-producing device 1 are as follows.

The first yoke 21 and the second yoke 22 of the sound-producing device 1 according to the embodiment are formed of an Fe—Ni alloy containing 32% by mass to 40% by mass of Ni. A feature of this Fe—Ni alloy is that it has a low linear expansion coefficient α.

“Fe—Ni alloy” as used herein refers to an alloy based on iron (Fe) and nickel (Ni). It should be understood that this term also encompasses alloys containing other minor constituents. Typically, in addition to Fe and Ni, about 0.7% by mass of manganese (Mn) and less than 0.2% by mass of carbon (C) are present as minor constituents.

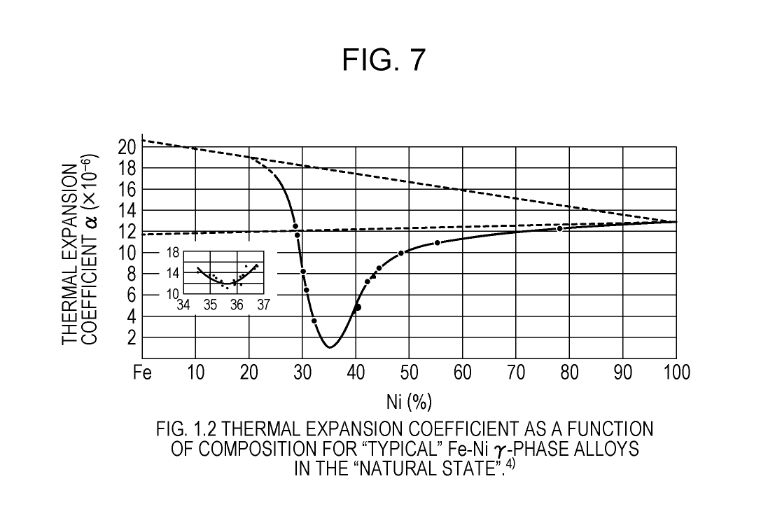

As shown in FIG. 7, Fe—Ni alloys containing 32% by mass to 40% by mass of Ni have linear expansion coefficients α of 5×10⁻⁶ or less, which are significantly lower than that of, for example, PB permalloy, which contains about 45% by mass of Ni.

As shown in FIG. 3, the sound-producing device 1 has the yokes 21 and 22 disposed adjacent to the coil 27 within the sealed narrow space of the case 2. Thus, for example, when a drive current with a high frequency of 2 kHz or more is supplied to the coil 27, the coil 27 generates an increased amount of heat, and this heat increases the temperature of the yokes 21 and 22 disposed adjacent thereto within the narrow space.

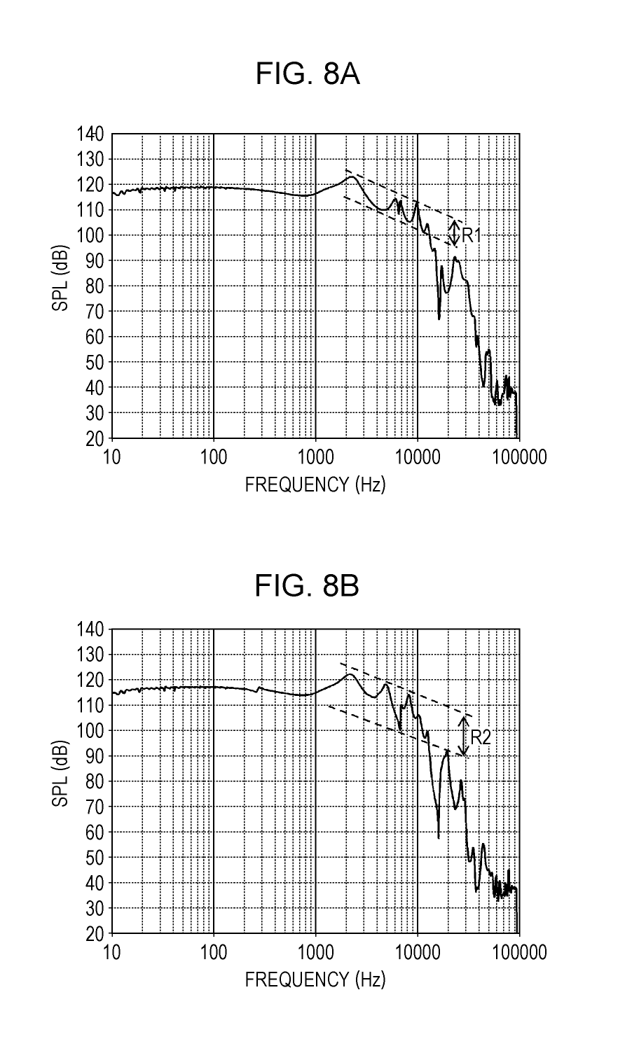

However, the yokes 21 and 22, which are formed of the Fe—Ni alloy described above, have a low linear expansion coefficient and thus deform only slightly at elevated temperatures. Thus, the distance δ between the first magnet 24 and the second magnet 25 varies only a little at elevated temperatures, so that unnecessary vibrations and resonance of the armature 32 due to the variation in distance δ can be suppressed. Since the yokes 21 and 22 deform only slightly, stress concentration at the junctions between the magnets 24 and 25 and the yokes 21 and 22 and stress concentration at the junction between the first yoke 21 and the second yoke 22 can be alleviated. Thus, the flow regularity of the magnetic flux generated by the magnets 24 and 25 and flowing from the first yoke 21 to the armature 32 is not impaired, and as shown in FIG. 8A, the ripple noise level R1 of the sound pressure level at high frequencies of 2 kHz or more can be reduced.

Although the magnetic-field generating unit 20 in the embodiment is composed of the first yoke 21 and the U-shaped second yoke 22, it is also possible to use a magnetic-field generating unit composed of a flat upper yoke, a flat lower yoke, and a pair of flat side yokes joined to the upper and lower yokes, that is, a total of four yokes.

### EXAMPLES

### (1) Example

A sound-producing device 1 serving as an Example included a first yoke 21 and a second yoke 22 that were formed of an Fe—Ni alloy containing 36% by mass of Ni. The plate thickness was 0.35 mm. A bulk of this alloy has a magnetic saturation of about 1.2 T. The width W1 of the yokes 21 and 22 shown in FIG. 2 in the Y direction was 1.6 mm, the width W2 of the second yoke 22 in the X direction was 2.7 mm, and the height H of the magnetic-field generating unit 20 in the Z direction was 1.8 mm.

The first magnet 24 and the second magnet 25 were AlNiCo magnets.

The number of turns of the coil 27 was 200 turns.

The armature 32 was formed of PB permalloy, i.e., an Fe—Ni alloy containing 45% by mass of Ni, and had a plate thickness of 0.15 mm.

The vibrating plate 11 was formed of aluminum and had a plate thickness of 0.05 mm.

### (2) Comparative Example

The first yoke 21 and the second yoke 22 were formed of PB permalloy, i.e., an Fe—Ni alloy containing 45% by mass of Ni. A bulk of PB permalloy has a magnetic saturation of about 1.5 T. The sizes of the first yoke 21 and the second yoke 22 and the structures of the magnetic-field generating unit 20 and the coil 27 were identical to those of the Example.

### (3) Sound Pressure Level (SPL) Measurement

SPL was measured with a model 5265-2A sound analyzer (available from Etani Electronics Co., Ltd.). A coupler compliant to IEC 60318-4 was used.

The sound pressure level was measured with a power of 1 mW at 1 kHz (constant applied voltage) in the range from 10 Hz to 100 kHz.

FIG. 8A shows the SPL measurement results for the Example, whereas FIG. 8B shows the SPL measurement results for the Comparative Example. Whereas the sound pressure levels in FIGS. 8A and 8B were similar over a wide range of frequencies of 2 kHz or more, the ripple noise level R1 of the Example in FIG. 8A was nearly half the ripple noise level R2 of the Comparative Example in FIG. 8B.

1. A sound-producing device comprising: a case, a yoke comprising a magnetic material, a magnet supported by the yoke, a coil, an armature extending through the coil and facing the magnet, and a vibrator configured to vibrate in response to operation of the armature,
wherein, the yoke, magnet, coil, armature and vibrator are in the case, and the yoke comprises an Fe—Ni alloy containing approximately 32% by mass to 40% by mass of Ni.

2. The sound-producing device according to claim 1, wherein the Fe—Ni alloy contains approximately 36% by mass of Ni.

3. The sound-producing device according to claim 1, wherein the magnet is secured to each of opposing inner surfaces of the yoke, the armature being located between the opposing magnets.

4. The sound-producing device according to claim 3, wherein a frame is disposed in the case, the vibrator being supported on one side of the frame, the yoke being secured to another side of the frame.

5. The sound-producing device according to claim 4, wherein the case comprises first and second cases combined together, the frame being held and secured between the first and second cases.
